(19) United States
(12) Patent Application Publication
(10) Pub. No.: US 2013/0300759 A1
(43) Pub. Date: Nov. 14, 2013

(54) METHOD AND APPARATUS FOR MODIFYING THE PRESENTATION OF INFORMATION BASED ON THE ATTENTIVENESS LEVEL OF A USER

(71) Applicant: Sean White, Mountain View, CA (US)

(72) Inventor: Sean White, Mountain View, CA (US)

(73) Assignee: NOKIA CORPORATION, Espoo (FI)

(21) Appl. No.: 13/466,178

(22) Filed: May 8, 2012

(51) Int. Cl. G09G 5/00; G09G 5/373; G09G 5/02

(52) U.S. Cl. 345/589; 345/619

(57) ABSTRACT

Methods, apparatuses, and computer program products are herein provided for modifying the presentation of information based on the attentiveness level of a user. A method may include determining a first attentiveness level of a user. The method may further include causing presentation of information on a display. The method may further include determining a second attentiveness level of the user following determination of the first attentiveness level of the user and while the information is being presented on the display. The method may further include causing, based on a relationship between the first attentiveness level and the second attentiveness level, modification of presentation of at least a portion of the information on the display. Corresponding apparatuses and computer program products are also provided.

### TECHNOLOGICAL FIELD

Example embodiments of the present invention relate generally to user interface technology and, more particularly, relate to methods, apparatuses, and computer program products for modifying the presentation of information based on the attentiveness level of a user.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

Increased functionality of mobile computing devices has led to increased use. Indeed, users often use these devices throughout the entire day, often while being fatigued. A fatigued user, however, may have difficulty effectively operating or utilizing the device, such as not being able to easily see small text or focus on small objects. This problem may be more significant with the use of pass-through displays (e.g., head-mounted displays, augmented reality glasses, video or optical see-through displays, etc.), where the user may rely on the device for notification of important information regarding the user's surroundings (e.g., the user is driving a car).

### BRIEF SUMMARY

As such, certain example embodiments of the present invention modify the presentation of information on the display based on the attentiveness level of the user. In such a manner, the information being presented can be optimized based on the attentiveness level of the user. For example, if a user is fatigued, an example embodiment of the present invention may make presentation of the information easier to perceive to aid a fatigued user in recognizing the information. Thus, some embodiments of the present invention provide a dynamic system that modifies the presented information based on the attentiveness level of the user in order to optimize the user's experience.

Embodiments of the present invention provide methods, apparatuses, and computer program products for modifying the presentation of information based on the attentiveness level of a user. In one example embodiment, a method includes determining a first attentiveness level of a user. The method further includes causing presentation of information on a display. The method further includes determining a second attentiveness level of the user following determination of the first attentiveness level of the user and while the information is being presented on the display. The method further includes causing, based on a relationship between the first attentiveness level and the second attentiveness level, modification of presentation of at least a portion of the information on the display.

In some embodiments, the method may further include causing modification of presentation of the at least a portion of the information by causing modification of presentation of the at least a portion of the information in an instance in which the second attentiveness level is different than the first attentiveness level. Additionally or alternatively, the method may further include causing modification of presentation of the at least a portion of the information by causing the at least a portion of the information to be presented such that the at least a portion of the information is easier to perceive. Additionally or alternatively, the method may further include causing modification of presentation of the at least a portion of the information by causing modification of at least one of font size or color scheme of the at least a portion of the information. Additionally or alternatively, the method may further include causing modification of presentation of the at least a portion of the information by causing at least a portion of the information presented on the display to be removed.

In some embodiments, the method may further include causing presentation of the information on the display by causing presentation of the information based on the first attentiveness level of the user.

In some embodiments, the method may further include determining the second attentiveness level by determining the second attentiveness level based at least in part on output provided by at least one of: a graze tracker, an accelerometer, or a heart rate monitor. Additionally or alternatively, the method may further include determining the second attentiveness level by determining the second attentiveness level based at least in part on detecting at least one of changes in movement or behavior of the user's eyes or changes in movement or behavior of the user's eyelids.

In another example embodiment, an apparatus includes at least one processor and at least one memory storing computer program code, wherein the at least one memory and stored computer program code are configured, with the at least one processor, to cause the apparatus to determine a first attentiveness level of a user. The at least one memory and stored computer program code are configured, with the at least one processor, to further cause the apparatus to cause presentation of information on a display. The at least one memory and stored computer program code are configured, with the at least one processor, to further cause the apparatus to determine a second attentiveness level of the user following determination of the first attentiveness level of the user and while the information is being presented on the display. The at least one memory and stored computer program code are configured, with the at least one processor, to further cause the apparatus to cause, based on a relationship between the first attentiveness level and the second attentiveness level, modification of presentation of at least a portion of the information on the display.

In another example embodiment, a computer program product is provided. The computer program product of this example embodiment includes at least one computer-readable storage medium having computer-readable program instructions stored therein. The program instructions of this example embodiment comprise program instructions configured to cause an apparatus to perform a method including determining a first attentiveness level of a user. The method further includes causing presentation of information on a display. The method further includes determining a second attentiveness level of the user following determination of the first attentiveness level of the user and while the information is being presented on the display. The method further includes causing, based on a relationship between the first attentiveness level and the second attentiveness level, modification of presentation of at least a portion of the information on the display.

In another example embodiment, an apparatus is provided. The apparatus comprises means for determining a first attentiveness level of a user. The apparatus further includes means for causing presentation of information on a display. The apparatus further includes means for determining a second attentiveness level of the user following determination of the first attentiveness level of the user and while the information is being presented on the display. The apparatus further includes means for causing, based on a relationship between the first attentiveness level and the second attentiveness level, modification of presentation of at least a portion of the information on the display.

### BRIEF DESCRIPTION OF THE DRAWINGS

Having thus described some embodiments of the invention in general terms, reference will now be made to the accompanying drawings, which are not necessarily drawn to scale, and wherein:

FIG. 1 illustrates a block diagram of an apparatus with a user interface according to an example embodiment;

FIG. 2 is a schematic block diagram of a mobile terminal according to an example embodiment;

FIG. 3A illustrates an example head-mounted display, wherein the display is pass-through such that a city skyline can be seen through the display, in accordance with an example embodiment of the present invention;

FIG. 3B illustrates an example windshield display for a car, wherein the display is pass-through such that a city skyline can be seen through the display, in accordance with an example embodiment of the present invention;

FIG. 4A illustrates an example device with a display, wherein application icons are presented on the display, in accordance with an example embodiment described herein;

FIG. 4B illustrates an example car with a windshield with a pass-through display, wherein driving directions are presented on the pass-through display, in accordance with an example embodiment described herein;

FIG. 5A illustrates the device shown in FIG. 4A, wherein presentation of the application icons has been modified, in accordance with an example embodiment described herein;

FIG. 5B illustrates the device shown in FIG. 4B, wherein presentation of the driving directions has been modified, in accordance with an example embodiment described herein;

FIG. 6A illustrates the device shown in FIG. 4A, wherein some of the application icons have been removed from being presented on the display, in accordance with an example embodiment described herein;

FIG. 6B illustrates the device shown in FIG. 4B, wherein a portion of the sun shining through the pass-through display has been covered up from the perspective of the user, in accordance with an example embodiment described herein;

FIG. 7A illustrates the device shown in FIG. 4B, wherein an enlarged stop sign has been presented on the pass-through display over the stop sign from the perspective of the user, in accordance with an example embodiment described herein;

FIG. 7B illustrates the device shown in FIG. 4B, wherein enlarged text directing the user to “STOP” has been presented on the pass-through display over the stop sign from the perspective of the user, in accordance with an example embodiment described herein;

FIG. 7C illustrates the device shown in FIG. 4B, wherein a portion of the sun shining through the pass-through display has been covered up from the perspective of the user and wherein the driving directions have been removed from being presented on the display, in accordance with an example embodiment described herein;

FIG. 8 illustrates a flowchart according to an example method for modifying the presentation of information based on the attentiveness level of a user, in accordance with an example embodiment described herein; and

FIG. 9 illustrates a flowchart according to another example method for modifying the presentation of information based on the attentiveness level of a user, in accordance with an example embodiment described herein.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to singular or plural data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

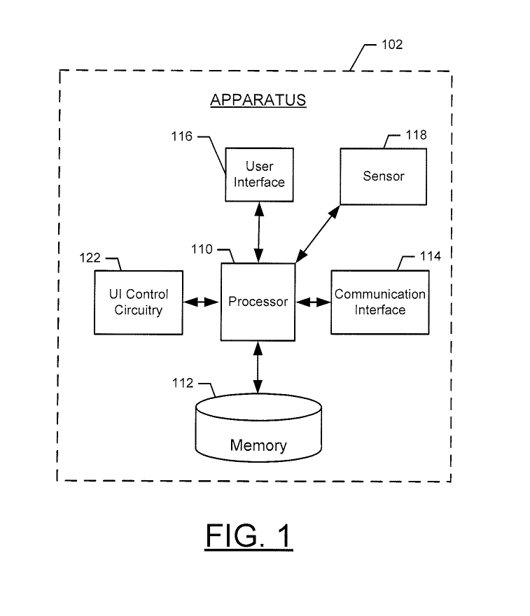

FIG. 1 illustrates a block diagram of an apparatus 102 for modifying the presentation of information based on the attentiveness level of a user. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for facilitating interaction with a user interface, other configurations may also be used to implement embodiments of the present invention.

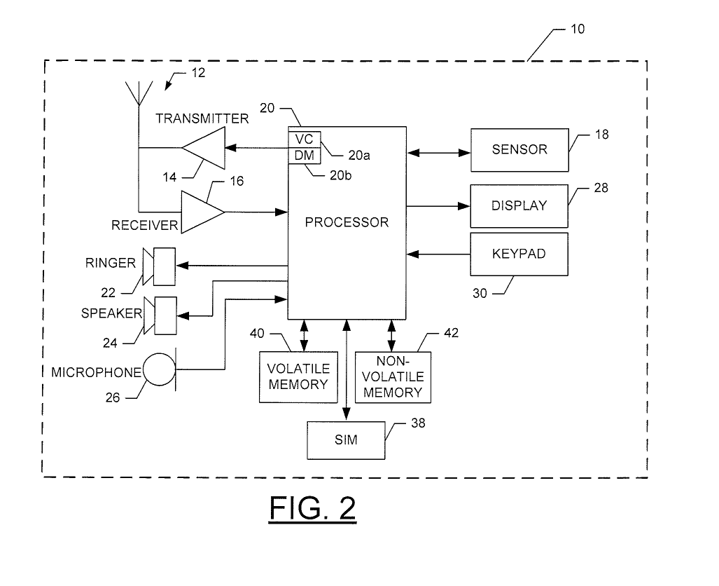

The apparatus 102 may be embodied as either a fixed device or a mobile device such as a desktop computer, laptop computer, mobile terminal, mobile computer, mobile phone, mobile communication device, game device, digital camera/camcorder, audio/video player, television device, radio receiver, digital video recorder, positioning device, a chipset, a computing device comprising a chipset, any combination thereof, and/or the like. In this regard, the apparatus 102 may comprise any computing device that comprises or is in operative communication with a display. In some example embodiments, the apparatus 102 is embodied as a mobile computing device, such as the mobile terminal illustrated in FIG. 2.

In this regard, FIG. 2 illustrates a block diagram of a mobile terminal 10 representative of one example embodiment of an apparatus 102. It should be understood, however, that the mobile terminal 10 illustrated and hereinafter described is merely illustrative of one type of apparatus 102 that may implement and/or benefit from various example embodiments of the invention and, therefore, should not be taken to limit the scope of the disclosure. While several embodiments of the computing device are illustrated and will be hereinafter described for purposes of example, other types of computing devices, such as mobile telephones, mobile computers, personal digital assistants (PDAs), pagers, laptop computers, desktop computers, gaming devices, positioning devices, tablet computers, televisions, e-papers, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs (e.g., applications), which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a pass-through display, a projector, a holographic display or the like. The display 28 may, for example, comprise a three-dimensional touch display, examples of which will be described further herein below. The user input interface may comprise devices allowing the mobile terminal to receive data, such as a keypad 30, a touch display (e.g., some example embodiments wherein the display 28 is configured as a touch display), a joystick (not shown), and/or other input device. In embodiments including a keypad, the keypad may comprise numeric (0-9) and related keys (#, *), and/or other keys for operating the mobile terminal 10. Alternatively or additionally, the keypad 30 may include a conventional QWERTY keypad arrangement.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may be non-transitory and may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the apparatus 102 includes various means for performing the various functions herein described. These means may comprise one or more of a processor 110, memory 112, communication interface 114, user interface 116, sensor 118, or user interface (UI) control circuitry 122. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, and/or UI control circuitry 122 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20 (shown in FIG. 2). In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42 (shown in FIG. 2). The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, and/or the like. This stored information may be stored and/or used by the UI control circuitry 122 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. In embodiments wherein the apparatus 102 is embodied as a mobile terminal 10, the communication interface 114 may be embodied as or comprise the transmitter 14 and receiver 16 (shown in FIG. 2). The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content, streaming media content, and/or the like) over a network from a server or other content source. The communication interface 114 may additionally be in communication with the memory 112, user interface 116, sensor 118, and/or UI control circuitry 122, such as via a bus.

The sensor 118 may be in communication with the processor 110, user interface 116, and/or UI control circuitry 122. In embodiments wherein the apparatus 102 is embodied as a mobile terminal 10, the sensor 118 may be embodied as or comprise the sensor 18 (shown in FIG. 2). In some embodiments, the sensor 118 may be configured detect changes in movement or behavior of a user's eyes. In some embodiments, the sensor 118 may be configured to track a user's gaze, such as by detecting the location and/or focus point of the user's eyes. For example, the sensor 118 may be configured to transmit a beam or other signal (e.g., an infrared light) that bounces off the user's eyes (e.g., the user's cornea). The sensor 118 may also be configured to receive the beam or other signal upon its return. Additionally or alternatively, the sensor 118 may use other functionality including, but not limited to pictures and/or video taken with a camera and/or detecting change in the user's eye-muscle related electrical activity, among others, to track the user's gaze. Along these same lines, the sensor 118 may be configured to detect the size of a user's pupil in order to determine the user's focus point in a three-dimensional environment (e.g., depth of the user's focus point). In some embodiments, the sensor 118 may provide output (e.g., signals, beams, pictures, videos, etc.) to the processor 110 to enable the processor 110 to determine certain circumstances regarding the user's gaze (e.g., location, focus point, etc.). This information may be used to determine changes in movement or behavior of the user's gaze. Similarly, the sensor 118 may be configured to monitor other features of the user, such as the movement of the user's eyelids, including excessive blinking or heavy-lidded behavior, among others. In some embodiments, the sensor 118 may comprise a gaze tracker. In such an embodiment, the sensor 118 may be configured to provide output indicative of the any of the above detections to the apparatus 102 (e.g., the processor 110), such as for determination of the attentiveness level of the user.

Additionally, in some embodiments, the sensor 118 may comprise a heart rate monitor to detect the heart rate of the user. In such an embodiment, the sensor 118 may be configured to provide an output to the apparatus 102 (e.g., the processor 110) to determine the heart rate of the user, such as for determination of the attentiveness level of the user. Similarly, in some embodiments, the sensor 118 may comprise an accelerometer to detect movement that may be indicative of the fatigue level of the user. For example, a head-mounted display may include an accelerometer that may be configured to detect if a user drops their head, such as may be indicative that the user is falling asleep, such as for determination of the attentiveness level of the user.

Additionally, in some embodiments, the sensor 118 may comprise a front-facing camera. In some embodiments, a front-facing camera may be useful for an apparatus with a pass-through display to help detect (e.g., with pictures, videos, etc.) the environment the user is looking at through the display (e.g., from the perspective of the user). Indeed, in some embodiments, the front-facing camera may provide output to the apparatus 102 (e.g., the processor 110), which may determine the environment, such as for replication and/or modification on the pass-through display.

Additionally, in some embodiments, the sensor 118 may comprise other types of sensors. For example, a galvanic skin response sensor may be used to measure the electrical conductance of the skin of the user. Such a sensor may be positioned near the user's eyes to detect changes in the user's gaze. Additionally or alternatively, the sensor 118 may comprise a sensor for detecting the body temperature of the user. Changes in body temperature may help determine the attentiveness level of the user.

As used herein, example embodiments of the apparatus 102 may include any type of sensor 118 or combination of sensors 118, such as a gaze tracker, proximity sensor, light sensor, gyroscope, camera, heart rate monitor, and/or accelerometer, among others.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. In embodiments wherein the apparatus 102 is embodied as a mobile terminal 10, the user interface 116 may be embodied as or comprise the display 28 and keypad 30 (shown in FIG. 2). The user interface 116 may be in communication with the memory 112, communication interface 114, sensor 118, and/or UI control circuitry 122, such as via a bus.

In some embodiments, the user interface 116 may comprise a pass-through display. Likewise, in embodiments wherein the apparatus 102 is embodied as a mobile terminal 10, the display 28 may be embodied as a pass-through display. In some embodiments, a pass-through display may be configured to present information (e.g., text, icons, pictures, videos, visual attractants, etc.) in an at least partially transparent form (e.g., image overlay) such that a user may be able to see through the information being presented.

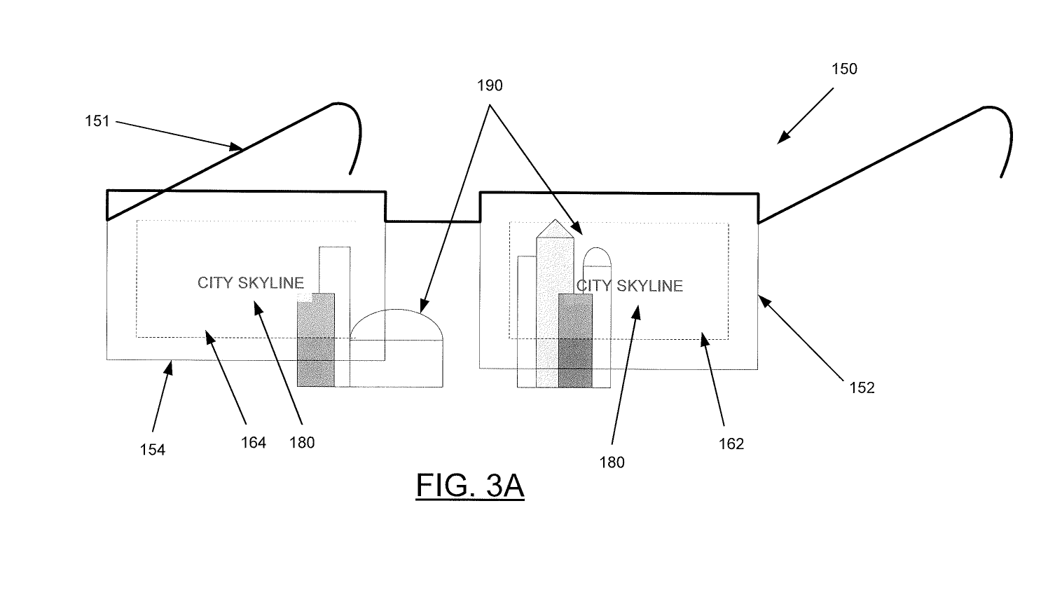

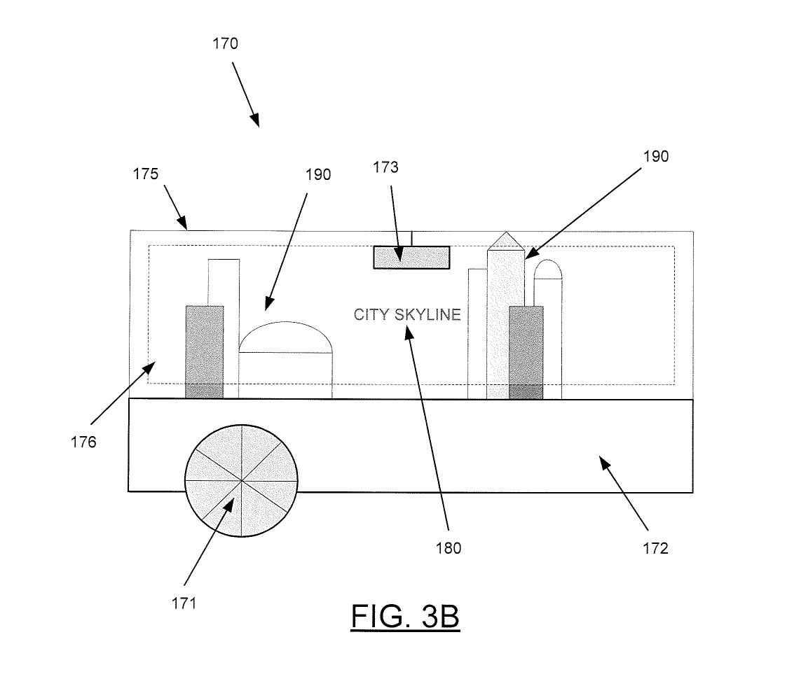

As such, some example embodiments may provide for an apparatus (e.g., apparatus 102) for providing input through a device comprising a display, such as the glasses 150 shown in FIG. 3A or the windshield 170 shown in FIG. 3B. The apparatus with a pass-through display may provide a visual overlay of information on a substantially transparent display surface, such as through lenses that appear to be normal optical glass lenses. This visual overlay allows a user to view objects and people in their typical, un-obscured field of view while providing additional information that may be displayed on the pass-through display. The visual overlay of the information may be of various opacity ranging from transparent (or 0% opacity) to opaque (or 100% opacity). For example, the information presented on the pass-through display may, in some cases, fully occlude the user's vision beyond the information presented on the display by being presented in a substantially opaque manner on a substantially transparent display. In some embodiments, the presented information may be partially transparent such that the wearer is able to see the environment beyond the pass-through display. The degree of transparency may be variable from fully transparent, where the information is not shown, to fully opaque or non-transparent, or any degree therebetween.

Example embodiments may also present information at the edges of the pass-through display. For example, the pass-through display of one embodiment may include a central area of the display which is substantially transparent with less transparent and possibly opaque information being presented around the substantially transparent area. Such an embodiment may allow a user to view their environment (e.g., environment information) through the central area, while also providing information for the user to view peripherally thereabout.

Presentation of information on a pass-through display coupled with object recognition allows for dynamically interactive information to be presented to a user. Apparatuses with pass-through displays allow for the presentation of two-dimensional (2-D) and/or three-dimensional (3-D) visual elements. Two-dimensional graphical elements rendered in the plane of the display can present the user with a user interface, status elements, or other information as would be viewed on a typical computer screen or display of a mobile terminal (e.g., display 28 of mobile terminal 10). Similarly, three-dimensional graphical elements may be rendered on top of the display or on top of the environment and seen through the pass-through display. In such a manner, these visual elements can communicate messages, alert the user with a notification, render an application that is currently in use, etc. Additionally, these visual elements may provide images regarding an object that a user of the pass-through display is viewing through the display, such as by identifying a point-of-interest or landmark that a user is viewing. Such identification may be accomplished by various means including object recognition software or object recognition in conjunction with location identification (e.g., via Global Positioning System (GPS) signals) of the apparatus (e.g., apparatus 102) or the device that embodies the apparatus, such as mobile terminal 10.

Additionally, in some embodiments, the apparatus (e.g., apparatus 102), may be multi-modal so as to provide additional feedback to the user. For example, the apparatus may provide audio feedback in addition to the presentation of information. Additionally or alternatively, the apparatus may provide tactile feedback (e.g., vibration) to the user.

Some examples of apparatuses (e.g., apparatus 102) with a pass-through display are illustrated in FIGS. 3A and 3B. FIG. 3A illustrates an example head-mounted display (e.g., glasses 150) that includes a left lens 154 and a right lens 152. Such left and right lens 152, 154 may be configured to interact with a user's left eye and right eye respectively. Additionally, the glasses 150 may include a frame 151 that is configured to engage with a user's head (e.g., ears) to mount to the user's head.

In some embodiments, the glasses 150 may comprise (or be in communication with) a processor (e.g., processor 110) that is configured to control presentation of information. For example, in the depicted embodiment of the glasses 150, the processor may be configured to control presentation of information to create a left lens display 164 and a right lens display 162. In some embodiments, the information presented on the left lens display 164 and right lens display 162 may be independent and/or they may be complementary.

As illustrated in FIG. 3A, a user (not shown) may look through the left lens 154 and right lens 152 and the left lens display 164 and right lens display 162 presented thereupon to see information, such as a city skyline 190. Additionally, in some embodiments, the glasses 150 may be configured to cause presentation on the left lens display 164 and/or right lens display 162. In the depicted embodiment, the description “CITY SKYLINE” 180 is being presented to the user in the left lens displays 164 and right lens display 162 to indicate that the user is looking at the skyline of the city (e.g., through the left lens 154 and right lens 152). Though words are shown as being presented on the display, some embodiments of the present invention contemplate presenting other types of information on the display (e.g., pictures, videos, notifications, visual attractants, etc.). Additionally, though the words shown in FIG. 3A are not transparent, some embodiments of the present invention contemplate presentation of at least partially transparent information on the display.

FIG. 3B illustrates an example car 170 that may embody the apparatus 102 with a windshield with a pass-through display. In the depicted embodiment, the car 170 includes a dashboard 172, steering wheel 171, rear-view mirror 173 and windshield 175. The windshield 175 includes a display 176. In some embodiments, the car 170 may comprise (or be in communication with) a processor (e.g., processor 110) that is configured to control presentation of information. For example, in the depicted embodiment of the car 170, the processor may be configured to control presentation of information on the display 176 of the windshield 175.

As illustrated in FIG. 3B, a user (not shown) may look through the windshield 175 and the display 176 to see environment information, such as a city skyline 190. Additionally, in some embodiments, the car 170 may be configured to cause presentation of information on the display 176. In the depicted embodiment, the description “CITY SKYLINE” 180 is being presented to the user on the display 176 to indicate that the user is looking at the skyline of the city (e.g., through the windshield 175). Though words are shown as being presented on the display, some embodiments of the present invention contemplate presenting other types of information on the display (e.g., pictures, videos, notifications, visual attractants, etc.). Additionally, though the words shown in FIG. 3A are not transparent, some embodiments of the present invention contemplate presentation of at least partially transparent information on the display.

It should also be noted that while FIGS. 3A and 3B each illustrate one example of an apparatus with a pass-through display, numerous other apparatuses configured with a pass-through display are contemplated for embodiments of the present invention (e.g., a helmet visor, a cockpit windshield, etc.). Moreover, embodiments of the present invention are not meant to be limited to apparatuses with pass-through displays, and may be useful with other example apparatuses, such as any apparatus 102 (e.g., mobile terminal 10) described herein (e.g., a mobile computing device, a fixed computing device, etc.) having or associated with the display.

Returning to FIG. 1, the UI control circuitry 122 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In some example embodiments wherein the UI control circuitry 122 is embodied separately from the processor 110, the UI control circuitry 122 may be in communication with the processor 110. The UI control circuitry 122 may further be in communication with one or more of the memory 112, communication interface 114, sensor 118, and/or user interface 116, such as via a bus.

The UI control circuitry 122 may be configured to receive user input from a user interface 116, such as a touch display. The user input or signal may carry positional information indicative of the user input. In this regard, the position may comprise a position of the user input in a two-dimensional space, which may be relative to the surface of the touch display user interface. For example, the position may comprise a coordinate position relative to a two-dimensional coordinate system (e.g., an X and Y axis), such that the position may be determined. Accordingly, the UI control circuitry 122 may determine a position of the user input such as for determining a portion of the display to which the user input correlates.

In some embodiments, the apparatus 102 may be configured to receive other forms of user input (e.g., speech, gestures, etc.). Similarly, receipt of touch input by a user should not be limited to the display and may include any portion of the apparatus 102.

In some embodiments, a touch display may be configured to enable the detection of a hovering gesture input. A hovering gesture input may comprise a gesture input to the touch display without making physical contact with a surface of the touch display, such as a gesture made in a space some distance above/in front of the surface of the touch display. As an example, the touch display may comprise a projected capacitive touch display, which may be configured to enable detection of capacitance of a finger or other input object by which a gesture may be made without physically contacting a display surface. As another example, the touch display may be configured to enable detection of a hovering gesture input through use of acoustic wave touch sensor technology, electromagnetic touch sensing technology, near field imaging technology, optical sensing technology, infrared proximity sensing technology, some combination thereof, or the like.

A user's attentiveness level may vary and is often based on a number of factors, including the current level of fatigue of a user. For example, a user may be wide awake in the morning with a high energy level, such as after a cup of coffee. Alternatively, a user may be less attentive when the user is tired, such after a long day of work.

The apparatus 102 may be configured to determine an attentiveness level of a user. For example, the apparatus 102 may be configured to determine a first attentiveness level of a user. In some embodiments, the apparatus 102 may be configured to determine the attentiveness level of a user with sensor 118, which, as noted above, may comprise a gaze tracker. In such embodiments, the sensor 118 may be configured to provide an output, such as to the processor 110, and the apparatus 102, such as the processor 110, may determine the attentiveness level of the user, based at least in part on the output of the sensor 118.

In some embodiments, the apparatus 102, such as the processor 110, may be configured to determine an attentiveness level of a user based at least in part on detecting at least one of changes in movement or behavior of the user's eyes or changes in movement or behavior of the user's eyelids. As noted above, the apparatus 102 may comprise a sensor 118 configured to monitor the user's eyes and/or eyelids, including changes in movement or behavior of the user's eyes and/or eyelids. In such an embodiment, the apparatus 102, such as the processor 110, may monitor the user's eyes and/or eyelids for changes that indicate a change in the attentiveness level of the user. For example, a user's eyes may be quick to move between data (e.g., presented information and/or environment information) such that the apparatus 102, such as the processor 110, may determine a high attentiveness level. However, if the user becomes fatigued then the user's eyes may not be as quick to move between data, thereby indicating that the user may be fatigued and, thus, the apparatus 102, such as the processor 110, may determine a low attentiveness level. Along these same lines, a user's eyelids may blink quickly when a user is alert, such that the apparatus 102, such as the processor 110, may determine a high attentiveness level. However, once a user becomes fatigued, the user's eyelids may take longer to blink (e.g., exhibit heavy-lidded behavior), thereby indicating that the user may be fatigued and, thus, the apparatus 102, such as the processor 110, may determine a low attentiveness level.

In some embodiments, the apparatus 102, such as the processor 110, may be configured to determine an attentiveness level of a user based at least in part on output provided by at least one of: a gaze tracker, an accelerometer, or a heart rate monitor. For example, as noted above, a gaze tracker (such as an example embodiment of sensor 118) may detect changes in movement or behavior of a user's eyes and/or eyelids, thereby indicating an attentiveness level of a user. Additionally or alternatively, an accelerometer (such as an example embodiment of sensor 118) may detect movement of the user and/or movement of the apparatus 102 that indicates the attentiveness level of the user. For example, a user's head may bob up and down if they are falling asleep. The apparatus 102 may be configured to detect this movement with an accelerometer, such as when the apparatus 102 comprises a head-mounted display (shown in FIG. 3A) or a mobile device (e.g., mobile terminal 10). A heart rate monitor (such as an example embodiment of sensor 118) may also be used to determine a user's attentiveness level. For example, the heart rate monitor may detect the heart rate of the user, such that a quickened heart rate may indicate an alert user, while a slowed heart rate may indicate a fatigued user.

While some embodiments of the present invention may determine an attentiveness level based on a discrete event (e.g., detecting a head bob, the user not opening their eyelids for a certain amount of time, etc.), other embodiments may determine an attentiveness level based on continuous or repeated monitoring of overall changes or trends (e.g., the reaction time of the user to recognize presented information or environment information decreases over time).

As used herein, the attentiveness level may be based on indications of the current alert and/or fatigue level of a user. Additionally, the attentiveness level may be defined by any absolute or relative qualifier (e.g., numbers, high/low, etc.). For example, a user that is highly alert may be determined to have an attentiveness level that is high. This same user, however, such as after a long day of working, may become fatigued and, thus, the apparatus 102, such as the processor 110, may determine that the user has an attentiveness level that is low. Similarly, the attentiveness level may be based on a number system (e.g., 0-10), such that a highly alert user may be determined to have an attentiveness level of 9 and a fatigued user may be determined to have an attentiveness level of 3.

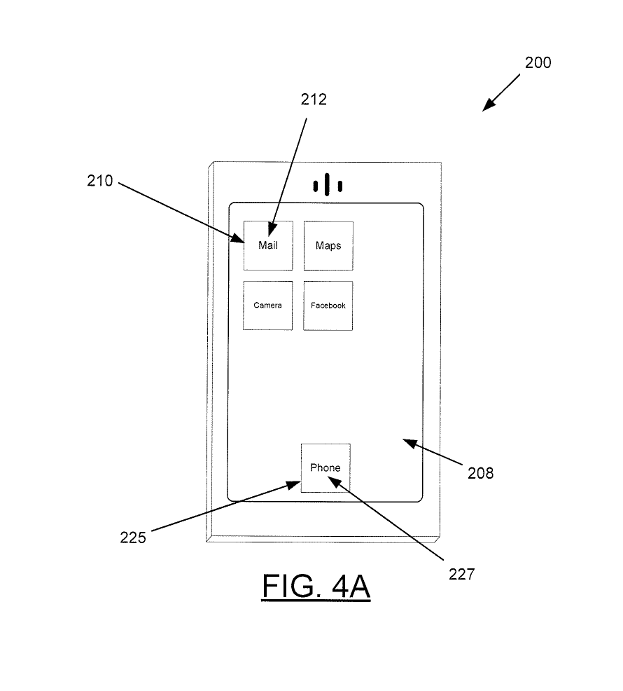

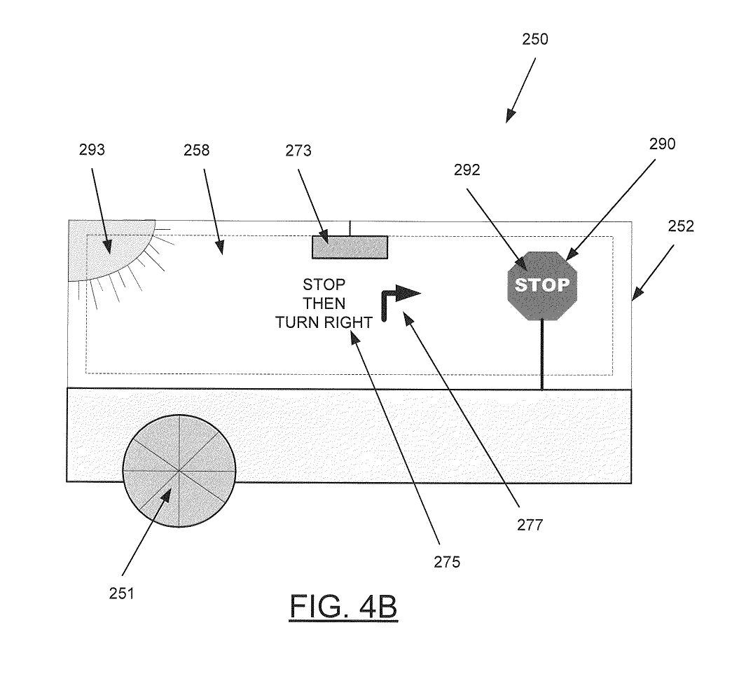

In some embodiments, the apparatus 102, such as the processor 110, may be configured to cause presentation of information on a display. The information presented on the display may be based on the operation being performed by the apparatus 102. For example, with reference to FIG. 4A, a computing device 200 (such as an example embodiment of apparatus 102) may include a display 208. Icons, such as the Mail icon 210 or Phone icon 225 may be presented as example information on the display 208. Additionally, in the depicted embodiment, a title of each icon is presented (e.g., “Mail” 212 for the Mail icon 210 and “Phone” 227 for the Phone icon 225).

In another example embodiment, with reference to FIG. 4B, an apparatus (e.g., apparatus 102) associated with a car 250 and a windshield 252, may include a pass-through display 258. The car 250 may also include a steering wheel 251 and a rear-view mirror 273. Environment information, such as the sun 293 and a stop sign 290 may be visible through the pass-through display 258. Additionally, the apparatus associated with the car 250 may cause presentation of information on the pass-through display 258. In the depicted embodiment, directions for a user (e.g., driver of the car 250) to “STOP THEN TURN RIGHT” 275 with a right turn arrow 277 are presented on the pass-through display 258.

In some embodiments, the apparatus 102, such as the processor 110, may be configured to cause presentation of information on the display based on the first attentiveness level of the user. For example, in some embodiments, the apparatus 102, such as the processor 110, may take into account the determined first attentiveness level of the user when causing presentation of the information on the display. In such a regard, as will be described in greater detail herein, the information can be presented in the most effective manner to the user. As an example, with reference to FIG. 4A, an alert user may not require large icons or large text for use of the device 200. It may be desirable, instead, to minimize the space on the display 208 devoted to such icons or text in favor of other icons or applications. Similarly, with reference to FIG. 4B, an alert user may not require large text or a large right turn arrow for recognition purposes. Moreover, it may be desirable to minimize this information in favor of environment information that may be otherwise blocked (at least partially) by the presented information.

As noted above, a user's attentiveness level may change during use of computing devices, such as apparatus 102 (e.g., extended use of such devices may lead to fatigue in a user). Additionally, a user may become fatigued for many other reasons. Additionally, in some cases, a user may be distracted, which may affect the attentiveness level of the user. The attentiveness level of a user may affect how well a user is able to utilize a device. For example, a fatigued user may have difficulty performing operations on the device, such as focusing on small text or keeping focused on small objects. As such, some embodiments of the present invention seek to monitor the attentiveness level of the user and modify presentation of the information based on the attentiveness level of the user. In such a manner, some embodiments may provide a dynamic display that adapts to the current attentiveness level of the user.

In some embodiments, the apparatus 102, such as the processor 110, may be configured to determine a second attentiveness level of the user. In some embodiments, the apparatus 102, such as the processor 110, may be configured to determine a second attentiveness level of the user following determination of the first attentiveness level of the user and while the information is being presented on the display. For example, as noted above, the apparatus 102, such as the processor 110, may be configured to determine an attentiveness level of a user based on the detection of certain characteristics regarding the user (e.g., changes in movement or behavior of the user's eyes and/or eyelids, heart rate of the user, movement of the user or apparatus, among others). This monitoring may occur over time after determination of the first attentiveness level, such as during presentation of information on a display of the apparatus 102. Additionally, in some embodiments, other factors may be used for determination of the attentiveness level of the user. For example, the attentiveness level of the user may be determined based on aggregate data from multiple users or canonical data from analysis of that aggregate data. Thus, social norms may be relevant to the determination of the attentiveness level of the user.

In some embodiments, the apparatus 102, such as the processor 110, may be configured to cause, based on a relationship between the first attentiveness level and the second attentiveness level, modification of presentation of at least a portion of the information on the display. In such a regard, the apparatus 102, such as the processor 110, may be configured to adapt the presentation of the information based on a change in the attentiveness level of the user.

For example, in some embodiments, the apparatus 102, such as the processor 110, may be configured to compare the first attentiveness level and the second attentiveness level. In such an embodiment, in the case that the user may have become fatigued since the determination of the first attentiveness level, the apparatus 102, such as the processor 110, may determine that the second attentiveness level is lower than the first attentiveness level. In such a circumstance, the apparatus 102, such as the processor 110, may be configured to cause a modification of presentation of at least a portion of the information such that at least a portion of the information is easier to perceive. This may enable the user to more easily recognize the presented information despite their fatigued state.

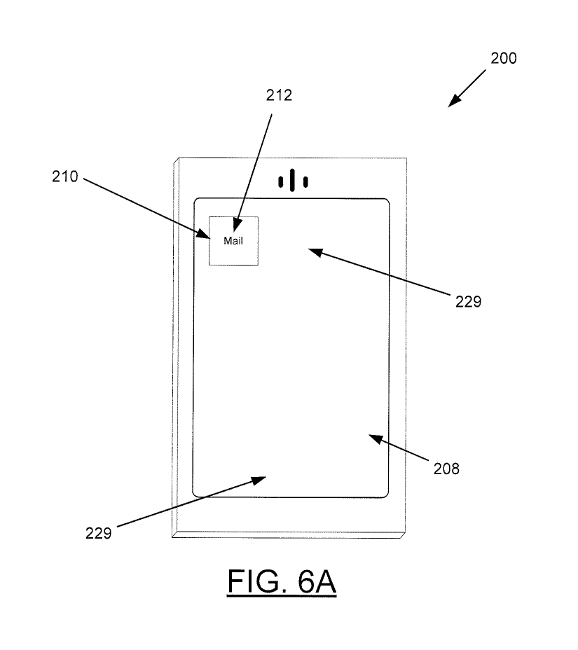

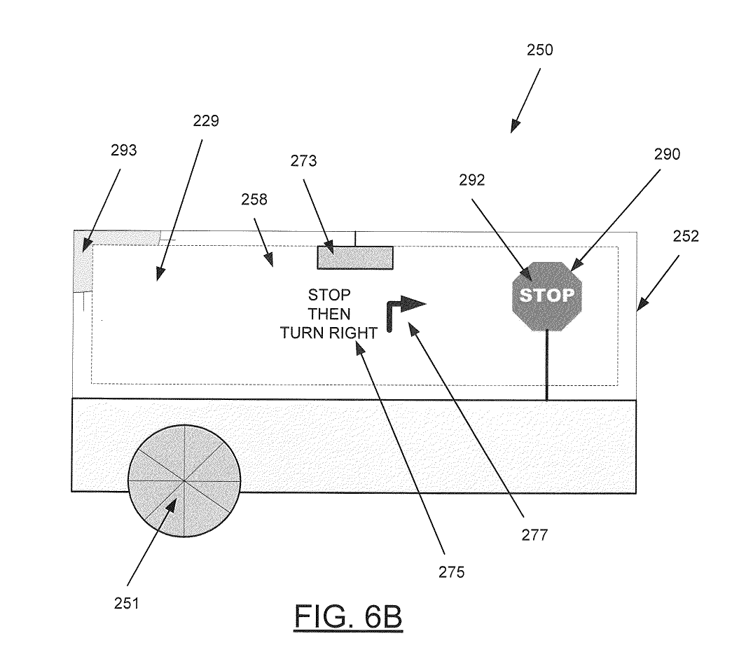

As used herein, many different ways to modify presentation of information to become “easier to perceive” are contemplated by embodiments of the present invention. For example, though example embodiments described herein show an increase in font size of text or shapes, other modifications are envisioned (e.g., font style, color, contrast, texture, location on the display, etc.). Similarly, example embodiments may modify the presentation of the display in other ways to cause information to be easier to perceive (e.g., remove distracting information or cover-up environment information such as described with respect to FIGS. 6A and 6B).

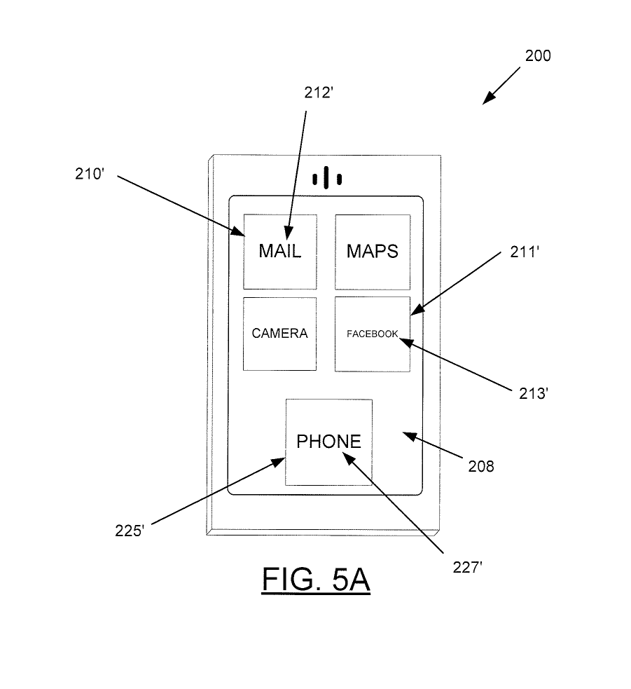

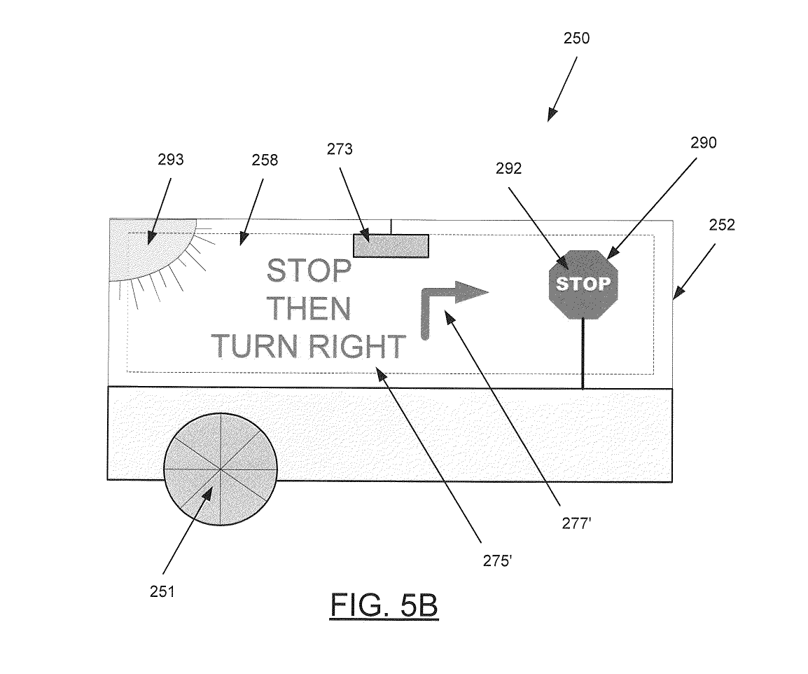

As noted above, in some embodiments, the apparatus 102, such as the processor 110, may be configured to cause a modification in at least one of font size or color scheme of that at least a portion of the information being presented. For example, as illustrated in FIG. 5A, the computing device 200 has modified presentation of the information (shown in FIG. 4A) to become easier to perceive. In the depicted embodiment, the Mail icon 210′ has been enlarged and the title “Mail” 212′ has also been enlarged with the font changed to all capital letters. Likewise, the Phone icon 225′ has been enlarged and the title “Phone” 227′ has also been enlarged with the font changed to all capital letters. In some embodiments, the degree of modification of certain information may be uniform across the display (e.g., the Mail icon 210′ and the Phone icon 225′). Additionally, however, in some embodiments, the degree of modification may vary based on portions of the information being presented. For example, the title “Facebook” 213′ of the Facebook icon 211′ may have not been enlarged as much as the title “Phone” 227′ of the Phone icon 225′. In such a regard, the apparatus 102 may be configured to modify presentation of information on some portions of the display differently from presentation of information on other portions of the display. In some embodiments, the degree of modification may be based on an importance level of the information being presented or the operation and/or environment information corresponding to the information being presented. Such an importance level may be determined by the apparatus 102 or may be pre-determined and/or pre-set, such as by the user.

FIG. 5B illustrates an example modification of presentation of information for an apparatus (e.g., apparatus 102) associated with a car 250 that includes a pass-through display 258. For example, the apparatus associated with the car 250 has modified presentation of the information (shown in FIG. 4B) to become easier to perceive. In the depicted embodiment, the driving directions “STOP THEN TURN RIGHT” 275′ have been enlarged and moved closer to steering wheel on the display 258. Additionally, the right turn arrow 277′ has also been enlarged on the display 258. In such a manner, the user (e.g., the driver) may more easily perceive the information being presented.

In some embodiments, the apparatus 102, such as the processor 110, may be configured to cause a modification by causing at least a portion of the information being presented on the display to be removed. In such a regard, the user may more easily perceive and/or focus on the remaining information being presented. For example, as illustrated in FIG. 6A, the computing device 200 has modified presentation of the information (shown in FIG. 4A) to remove the remaining icons (e.g., the Phone icon shown in FIG. 4A). These icons have been replaced by blank space 229 on the display 208. Thus, the user may now more easily perceive the Mail icon 210 and its corresponding title “Mail” 212. In this regard, the apparatus 102, such as the processor 110, may be configured to cause removal of a portion of the information being presented in favor of another portion of the information being presented.

FIG. 6B illustrates an example modification of presentation of information for an apparatus (e.g., apparatus 102) associated with a car 250 that includes a pass-through display 258. In the depicted embodiment, the apparatus associated with the car 250 has modified presentation of the information (shown in FIG. 4B) to cover-up environment information from the perspective of the user. The apparatus has blocked the light from the sun 293, which in some cases may remove the glare from the windshield 252. As illustrated in FIG. 6B, a portion of the sun 293 has been replaced by a blank space 229 on the display 258. Thus, the driving directions “STOP THEN TURN RIGHT” 275 and the right turn arrow 277 may be easier to perceive.

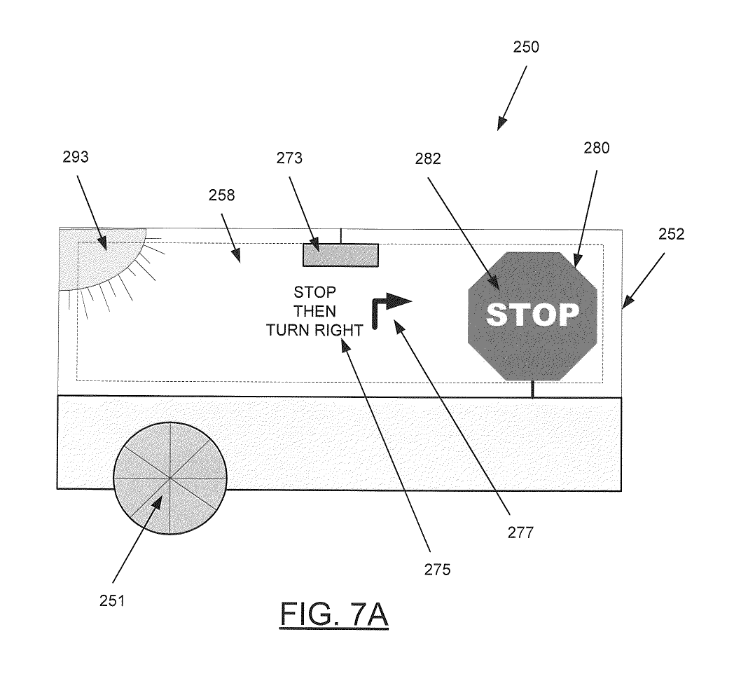

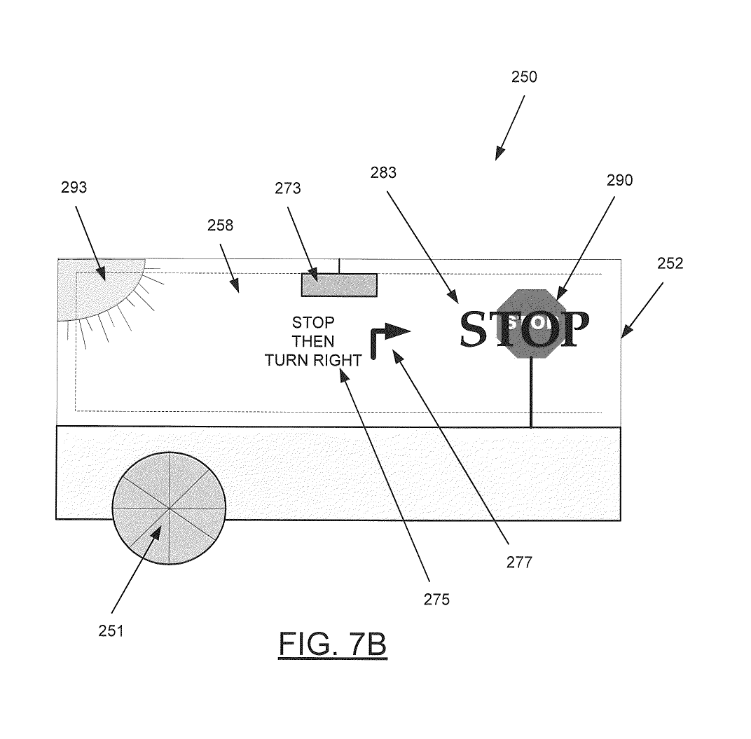

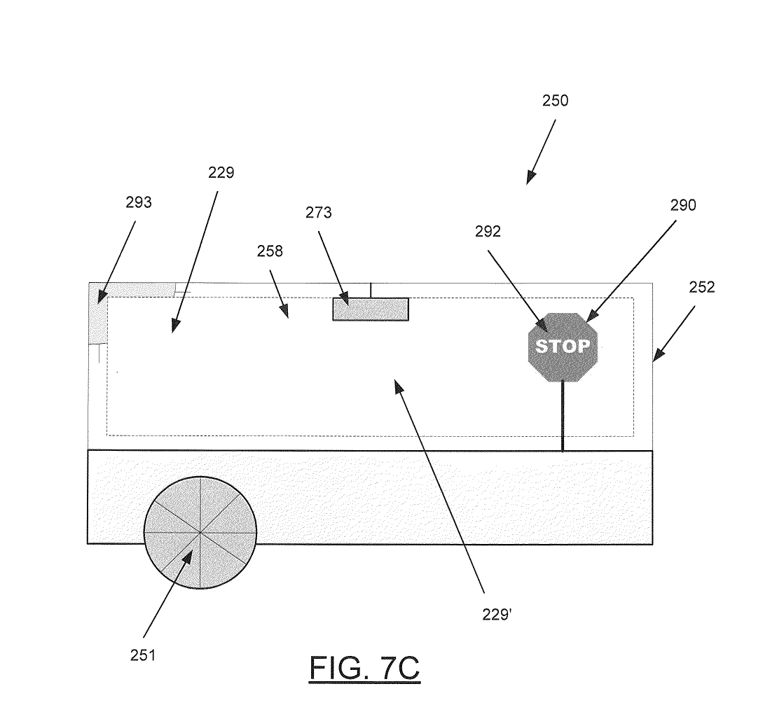

Additionally or alternatively, in embodiments in which the apparatus 102 comprises a pass-through display, the apparatus 102, such as the processor 110, may be configured to cause a modification of presentation of at least a portion of the information such that at least a portion of the environment information is easier to perceive. For example, FIGS. 7A, 7B, and 7C illustrate example modifications or presentation of the information to enable the environment information to become easier to perceive. Embodiments of the present invention are not meant to be limited to these example modifications, as other modifications are contemplated (e.g., highlighting the environment information, changing the color of the environment information, etc.)

In some embodiments, the apparatus 102, such as the processor 110, may be configured to modify presentation of information in the line of sight of the user to enable the user to more easily perceive the environment information. For example, with reference to FIG. 7A, the apparatus associated with the car 250 that includes a pass-through display 258 has modified presentation of information on the display 258 to enable a user to more easily recognize the stop sign 290 (shown in FIG. 4A). In particular, the apparatus associated with the car 250 has presented an enlarged sign 280 with the word “STOP” 282 located within, thereby presenting an over-sized stop sign to the user (e.g., the driver).

Similarly, with reference to FIG. 7B, the apparatus associated with the car 250 that includes a pass-through display 258 has modified presentation of information on the display 258 to enable a user to more easily recognize the need of the user to stop the car 250 (e.g., based on the stop sign 290 shown in FIG. 4A). In particular, the apparatus associated with the car 250 has presented the word “STOP” 283 over the stop sign 290 seen through the display 258.

In some embodiments, the apparatus 102, such as the processor 110, may be configured to modify presentation of other information to enable the user to more easily perceive the environment information. For example, with reference to FIG. 7C, the apparatus associated with the car 250 that includes a pass-through display 258 has modified presentation of information on the display 258 to enable a user to more easily recognize the stop sign 290. In particular, both environment information (e.g., the sun 293) and information being previously presented (e.g., the driving directions “STOP THEN TURN RIGHT” 275 and the right turn arrow 277) have been replaced and/or removed to enable the user to more easily perceive the stop sign 290. As illustrated in FIG. 7C, a portion of the sun 293 has been replaced by a blank space 229 on the display 258 and the driving directions 275 and right turn arrow 277 have been removed (e.g., near blank space 229′) from the display 258.

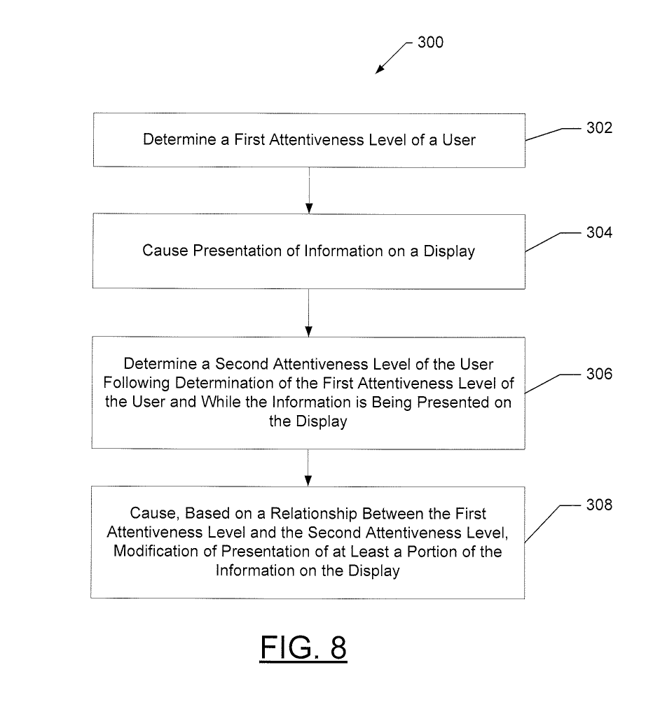

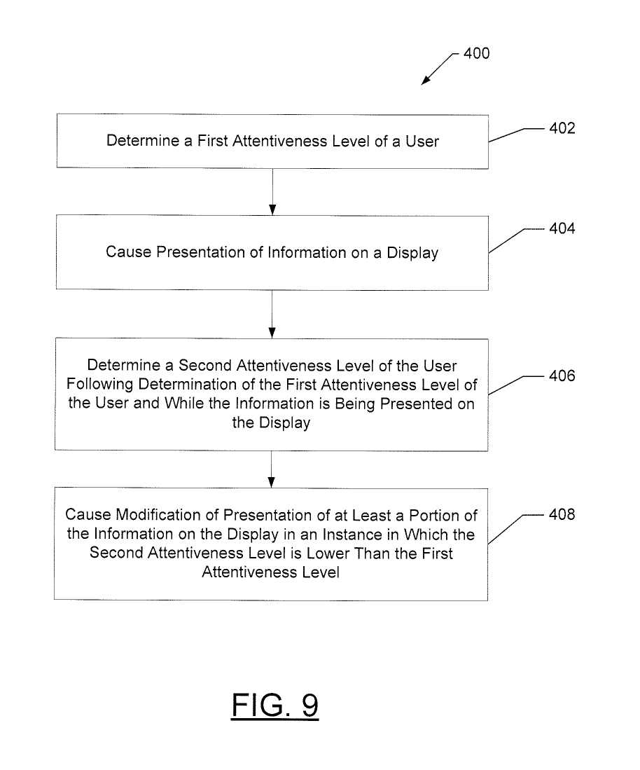

Embodiments of the present invention provide methods, apparatus and computer program products for modifying the presentation of information based on the attentiveness level of a user. Various examples of the operations performed in accordance with embodiments of the present invention will now be provided with reference to FIGS. 8-9.

FIG. 8 illustrates a flowchart according to an example method for modifying the presentation of information based on the attentiveness level of a user according to an example embodiment 300. The operations illustrated in and described with respect to FIG. 8 may, for example, be performed by, with the assistance of, and/or under the control of one or more of the processor 110, memory 112, communication interface 114, user interface 116, or UI control circuitry 122. Operation 302 may comprise determining a first attentiveness level of a user. The processor 110, communication interface 114, user interface 116, sensor 118, and/or UI control circuitry 122 may, for example, provide means for performing operation 302. Operation 304 may comprise causing presentation of information on a display. The processor 110, user interface 116, and/or UI control circuitry 122 may, for example, provide means for performing operation 304. Operation 306 may comprise determining a second attentiveness level of a user following determination of the first attentiveness level of the user and while the information is being presented on the display. The processor 110, communication interface 114, user interface 116, sensor 118, and/or UI control circuitry 122 may, for example, provide means for performing operation 306. Operation 308 may comprise causing, based on a relationship between the first attentiveness level and the second attentiveness level, modification of presentation of at least a portion of the information on the display. The processor 110, user interface 116, and/or UI control circuitry 122 may, for example, provide means for performing operation 308.

FIG. 9 illustrates a flowchart according to an example method for modifying the presentation of information based on the attentiveness level of a user according to an example embodiment 400. The operations illustrated in and described with respect to FIG. 9 may, for example, be performed by, with the assistance of, and/or under the control of one or more of the processor 110, memory 112, communication interface 114, user interface 116, or UI control circuitry 122. Operation 402 may comprise determining a first attentiveness level of a user. The processor 110, communication interface 114, user interface 116, sensor 118, and/or UI control circuitry 122 may, for example, provide means for performing operation 402. Operation 404 may comprise causing presentation of information on a display. The processor 110, user interface 116, and/or UI control circuitry 122 may, for example, provide means for performing operation 404. Operation 406 may comprise determining a second attentiveness level of a user following determination of the first attentiveness level of the user and while the information is being presented on the display. The processor 110, communication interface 114, user interface 116, sensor 118, and/or UI control circuitry 122 may, for example, provide means for performing operation 406. Operation 408 may comprise causing modification of presentation of at least a portion of the information on the display in an instance in which the second attentiveness level is lower than the first attentiveness level. The processor 110, user interface 116, and/or UI control circuitry 122 may, for example, provide means for performing operation 408.

FIGS. 8-9 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
determining, by a processor, a first attentiveness level of a user;
causing presentation of information on a display;
determining a second attentiveness level of the user following determination of the first attentiveness level of the user and while the information is being presented on the display; and
causing, based on a relationship between the first attentiveness level and the second attentiveness level, modification of presentation of at least a portion of the information on the display.

2. The method according to claim 1, wherein causing modification of presentation of the at least a portion of the information comprises causing modification of presentation of the at least a portion of the information in an instance in which the second attentiveness level is different than the first attentiveness level.

3. The method according to claim 1, wherein causing modification of presentation of the at least a portion of the information comprises causing the at least a portion of the information to be presented such that the at least a portion of the information is easier to perceive.

4. The method according to claim 1, wherein causing presentation of the information on the display comprises causing presentation of the information based on the first attentiveness level of the user.

5. The method according to claim 1, wherein determining the second attentiveness level comprises determining the second attentiveness level based at least in part on output provided by at least one of: a graze tracker, an accelerometer, or a heart rate monitor.

6. The method according to claim 1, wherein causing modification of presentation of the at least a portion of the information comprises causing at least a portion of the information presented on the display to be removed.

7. The method according to claim 1, wherein causing modification of presentation of the at least a portion of the information comprises causing modification of at least one of font size or color scheme of the at least a portion of the information.

8. The method according to claim 1, wherein determining the second attentiveness level comprises determining the second attentiveness level based at least in part on detecting at least one of changes in movement or behavior of the user's eyes or changes in movement or behavior of the user's eyelids.

9. An apparatus comprising a processor and a memory including computer program code, the memory and the computer program code configured to, with the processor, cause the apparatus to:
determine a first attentiveness level of a user;
cause presentation of information on a display;
determine a second attentiveness level of the user following determination of the first attentiveness level of the user and while the information is being presented on the display; and
cause, based on a relationship between the first attentiveness level and the second attentiveness level, modification of presentation of at least a portion of the information on the display.

10. The apparatus of claim 9, wherein the memory and the computer program code are further configured to, with the processor, cause the apparatus to cause modification of presentation of the at least a portion of the information by causing modification of presentation of the at least a portion of the information in an instance in which the second attentiveness level is different than the first attentiveness level.

11. The apparatus of claim 9, wherein the memory and the computer program code are further configured to, with the processor, cause the apparatus to cause modification of presentation of the at least a portion of the information by causing the at least a portion of the information to be presented such that the at least a portion of the information is easier to perceive.

12. The apparatus of claim 9, wherein the memory and the computer program code are further configured to, with the processor, cause the apparatus to cause presentation of the information on the display by causing presentation of the information based on the first attentiveness level of the user.

13. The apparatus of claim 9, wherein the memory and the computer program code are further configured to, with the processor, cause the apparatus to determine the second attentiveness level by determining the second attentiveness level based at least in part on output provided by at least one of: a graze tracker, an accelerometer, or a heart rate monitor.

14. The apparatus of claim 9, wherein the memory and the computer program code are further configured to, with the processor, cause the apparatus to cause modification of presentation of the at least a portion of the information by causing at least a portion of the information presented on the display to be removed.

15. The apparatus of claim 9, wherein the memory and the computer program code are further configured to, with the processor, cause the apparatus to cause modification of presentation of the at least a portion of the information by causing modification of at least one of font size or color scheme of the at least a portion of the information.

16. The apparatus of claim 9, wherein the memory and the computer program code are further configured to, with the processor, cause the apparatus to determine the second attentiveness level by determining the second attentiveness level based at least in part on detecting at least one of changes in movement or behavior of the user's eyes or changes in movement or behavior of the user's eyelids.

17. Computer program product comprising a non-transitory computer readable medium having program code portions means stored thereon, the program code portions being a computer readable medium and configured when said program product is run on a computer or network device, to:
determine a first attentiveness level of a user;
cause presentation of information on a display;
determine a second attentiveness level of the user following determination of the first attentiveness level of the user and while the information is being presented on the display; and
cause, based on a relationship between the first attentiveness level and the second attentiveness level, modification of presentation of at least a portion of the information on the display.

18. The computer program product of claim 17, wherein the program code portions are further configured when said program product is run on a computer or network device, to cause modification of presentation of the at least a portion of the information by causing modification of presentation of the at least a portion of the information in an instance in which the second attentiveness level is different than the first attentiveness level.

19. The computer program product of claim 17, wherein the program code portions are further configured when said program product is run on a computer or network device, to cause modification of presentation of the at least a portion of the information by causing the at least a portion of the information to be presented such that the at least a portion of the information is easier to perceive.

20. The computer program product of claim 17, wherein the program code portions are further configured when said program product is run on a computer or network device, to cause presentation of the information on the display by causing presentation of the information based on the first attentiveness level of the user.
